(19) United States
(12) Patent Application Publication
(10) Pub. No.: US 2020/0051092 A1
(43) Pub. Date: Feb. 13, 2020

(54) SYSTEM AND METHOD FOR PRODUCT RECALL USING BLOCKCHAIN

(71) Applicant: Walmart Apollo, LLC, Bentonville, AR (US)

(72) Inventors: Derric D'Souza, Bentonville, AR (US); Precious N. Baugh, Rogers, AR (US); Rachel A. D'Souza, Bentonville, AR (US); Greg L. Sanders, Fayetteville, AR (US); Enoch Acheampong, Fayetteville, AR (US); Michael Williams, Bentonville, AR (US); Michael Andrew Budell Fischer, Bentonville, AR (US)

(21) Appl. No.: 16/532,736

(22) Filed: Aug. 6, 2019

Related U.S. Application Data
(60) Provisional application No. 62/717,098, filed on Aug. 10, 2018.

(51) Int. Cl. G06Q 30/00; G06F 16/27; G06Q 40/00; G06Q 10/08

(52) U.S. Cl. CPC G06Q 30/014; G06Q 10/087; G06Q 40/12; G06F 16/27

(57) ABSTRACT

At a retail store or product storage location, a product is received and sold to a customer in a sales transaction. The sale transaction is recorded on a blockchain ledger, and the sales transaction includes customer identification information. A recall report is received concerning the product. The blockchain ledger is accessed and customers that purchased the recalled product are identified using the customer identification information. An action to take is determined. The action utilizes the contact information of customers that purchased the recalled product.

### CROSS-REFERENCE TO RELATED APPLICATIONS

This application claims the benefit of the following: U.S. Provisional Application No. 62/717,098 filed Aug. 10, 2018, which is incorporated herein by reference in its entirety.

### TECHNICAL FIELD

These teachings relate to product recalls and, more specifically, to utilizing a blockchain ledger to facilitate the determination of actions to take upon a product recall.

### BACKGROUND

Products sold in retail stores may be recalled for a variety of reasons. A product recall may occur, for example, when the product has a defect that can be dangerous for customers. Other recalls occur when features of a product are not meeting predetermined standards.

Customers purchase products at retail stores directly, on-line, using mobile applications, or using controlled kiosks to mention a few examples. When product recalls occur, recall information is typically posted on the recall boards in the customer service area of the store, on the empty shelves or on electronic recall boards. Customers need to be at the store to view the recall, or rely on the media for information concerning the recall. This can be inconvenient for many customers.

### BRIEF DESCRIPTION OF THE DRAWINGS

The above needs are at least partially met through the provision of approaches that determine action to take upon a product recall, wherein:

FIG. 1 comprises a diagram of a system as configured in accordance with various embodiments of these teachings;

FIG. 2 comprises a flowchart as configured in accordance with various embodiments of these teachings;

FIG. 3 comprises a flowchart as configured in accordance with various embodiments of these teachings;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings;

FIG. 9 comprise a system diagram configured in accordance with various embodiments of these teachings.

### DETAILED DESCRIPTION

Generally speaking, a system is provided that utilizes a blockchain ledger to manage actions taken after a product recall occurs. The ledger includes all transactions involving one or more products when the product is in or moves through a supply chain. Information concerning the transactions may be obtained by sensors embedded or associated with the product shipment as the shipment moves through the chain. For example, an internet of things (IoT) sensor is embedded in a crate of produce. When shipped, this sensor may obtain various types of information (e.g., product identifier, product type, date, time, temperature of product, and ID of producer) and this information is sent as a publishing request to add it to the ledger.

Eventually, the product reaches the retail store, where it is sold to a customer. The sales transaction is also added to the ledger and this sales transaction includes customer contact information. Then, a product recall occurs. The recall information is matched against information in the ledger to identify customers that purchased the recalled product. Actions such as contacting the customer or issuing the customer a replacement product can also occur.

In many of these embodiments, a system that is configured to perform remedial actions upon the occurrence of a product recall includes a control circuit, a database, a blockchain ledger stored at the database, a retail store or product storage location that offers a product for sale, and plurality of electronic transaction recording devices.

The plurality of electronic transaction recording devices are disposed at separate remote locations. The remote locations are transaction points in a supply chain, such that the product moves through each of the remote locations and to the retail store or product storage location. Each of the electronic transaction recording devices comprises a sensor, and the sensor is configured to record transactional information associated with the product as the product moves along the supply chain through each of the remote locations. Each of the plurality of electronic transaction recording devices causes the transactional information to be stored on the blockchain ledger.

The retail store or product storage location receives the product and sells the product to a customer in a sales transaction. The sale transaction is recorded on the blockchain ledger, and the sales transaction includes customer identification information and customer contact information.

The control circuit is configured to receive a recall report concerning the product. The control circuit is further configured to access the blockchain ledger and identify customers that purchased the recalled product using the customer identification information. The control circuit is still further configured to determine an action to take. The action utilizes the contact information of the identified customers that purchased the recalled product.

In aspects, the transactional information is evaluated before the product is received at the retail store or product storage location. In other aspects, after the transactional information is evaluated, the shipment of the product to the store is halted. The halting may occur before the product reaches the retail store.

In other examples, product traceability information of the product is obtained and added to the blockchain ledger. The traceability information relates to past or current locations of the product.

In still other examples, each of the remote locations may be a location of the producer of the product, a location of a supplier of the product, or a location of a shipper of the product. Other examples are possible.

In yet other aspects, the transaction recording device is an internet-of-things (IoT) device. Other examples transaction recording devices are possible.

In examples, the action comprises sending an electronic message to customers who purchased the recalled product or receiving a returned product at an automated vehicle. Other examples of actions are possible.

In still other examples, a second sensor is disposed with the product. The second sensor transmits information associated with condition of the product. The sensed information is stored on the blockchain ledger. In yet other aspects, the sales transaction is an on-line transaction. Other types of transactions are possible.

In others of these embodiments, an approach for determining remedial actions upon the occurrence of a product recall is provided. A blockchain ledger is stored, for example, in a database. Products are offered for sale at a retail store or product storage location.

A plurality of electronic transaction recording devices are disposed at separate remote locations. The remote locations are transaction points in a supply chain. The product moves (e.g., is manufactured then transported in a vehicle) through each of the remote locations and to the retail store or product storage location. Each of the electronic transaction recording devices comprises a sensor, and the sensor is configured to record transactional information associated with a product moving along the supply chain through each of the remote locations. The plurality of transaction recording devices causes the transactional information to be stored on the blockchain ledger.

At the retail store or product storage location, the product is received and sold to a customer in a sales transaction. The sale transaction is recorded on the blockchain ledger, and the sales transaction includes customer identification information.

Subsequently, a recall report is received concerning the product. The blockchain ledger is accessed and customers that purchased the recalled product are identified using the customer identification information.

An action to take is determined. The action utilizes the contact information of customers that purchased the recalled product.

The present approaches provide various advantages including the auto-lookup of customer information that can be used to determine all in-store (or on-line) purchasers of a product based upon their purchase history. In aspects, the approaches described herein automatically send push notification messaging to targeted customers, automatically send email notification messaging to targeted customers, automatically send text/short message service (SMS) notifications with recall messaging to targeted customers, and/or complement the in-store recall signage and cover a wider range of customers by pro-actively finding and notifying targeted customers electronically.

The approaches described herein are also able to identify all customers that purchased a recalled item (e.g., in-store and online) within a specific time frame so that the customers can be notified about next steps. Next steps can include, among other things, replacement or repair of the product.

In other aspects, customers with in-store (or on-line) purchases are notified of a related product that has been recalled. In-store or on-line customers will be notified via text/SMS, push, or email notifications on their own electronic devices. In some examples, the push notifications will provide a short summary and (e.g., upon a touch or tap from the customer on a touch screen) open a website to provide detailed recall information and action steps for the customer. In other aspects, the email notifications contain detailed recall information and action steps for the customer. The text/SMS notifications similarly contain, in examples, detailed recall information and action steps for the customer. In still other examples, an embedded URL pointing to a website will also be available for all the above-mentioned notifications.

In other examples, a manager or other decision maker can initiate the sending of the recall information, report, or notice or it may be automatically generated. The manager may input a UPC code or number, and an optional date range. The output from the process may include all customer contact information (e.g., first name, last name, e-mail address, contact number, and address to mention a few examples) and receipt details for the given UPC number. This information can then be utilized to instigate and/or facilitate a customer contact.

Various benefits are achieved by utilizing blockchain technology. For instance, the use of blockchain technology provides the ability to trace the recall issues back to particular places in the supply chain so as to isolate product problems and prevent any further outbreaks (of problems concerning the product) from occurring. The use of blockchain technology also reduces the amount of time it takes to identify the source (or potential sources) of the problem that led to the recall, which leads to a faster problem resolution time. Furthermore, the use of blockchain technology improves regulatory compliance with the ability to trace specific products and not an extensive list of items.

Using blockchain technology to record the supply chain transactions also provides an immutable history of product movement, condition, and other transactional information to provide better transparency. For instance, the use of blockchain technology provides transparency of a product's movement from the producer (or manufacturer) of the product to the customer. The data captured in the blockchain ledger includes (but is not be limited to) customer information and transaction details. Transactions may utilize any of the mobile or online payment venues, and other forms of traceable payments where financial institutions participate.

When product recalls are initiated, the present approaches allow for only those customers that have purchased the recalled products to receive the targeted notifications. Additionally, traceability for recalled products, and notifications to the targeted customers can be managed within minutes, instead of weeks and months. Customers can be immediately compensated for the recalled product, upon the recall taking effect. Targeted customers can be notified immediately, so they can initiate a return on their mobile device, and receive an instant (or almost instant) refund.

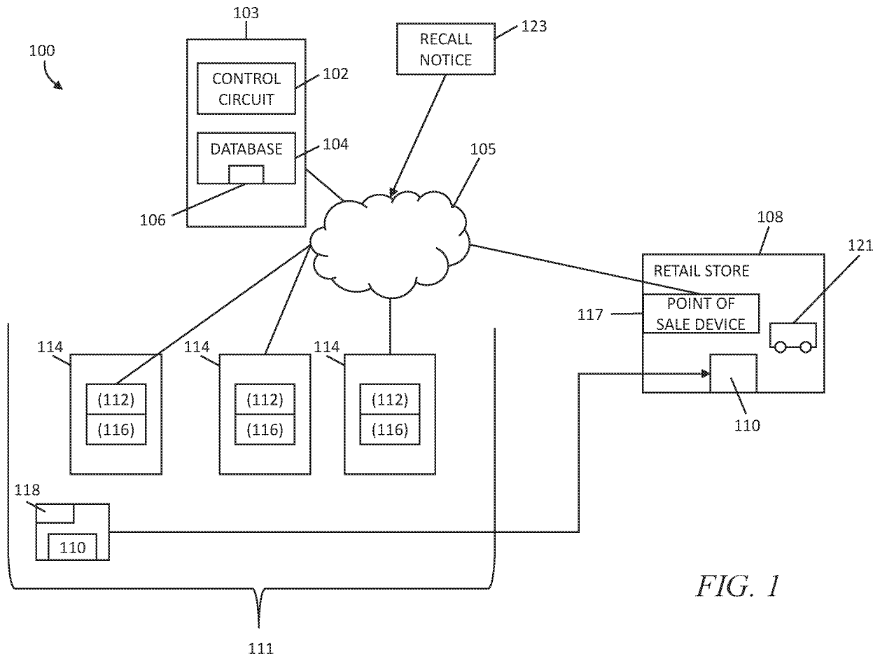

Referring now to FIG. 1, a system 100 that is configured to perform remedial actions upon the occurrence of a product recall includes a control circuit 102, a database 104, a blockchain ledger 106 (stored at the database 104), a retail store 108 (or product storage location such as a warehouse) that offers a product 110 for sale, and plurality of electronic transaction recording devices 112. A computer network 105 may couple these elements together. The network 105 may be any type of electronic communication network or combination of networks such as the internet.

The plurality of electronic transaction recording devices 112 are disposed at separate remote locations 114. The remote locations 114 are transaction points in a supply chain 111, such that the product moves through each of the remote locations 114 and to the retail store 108. The remote locations 114 may be a producer, a supplier, a warehouse, a storage unit, a shipping facility, a shipping vehicle, or a shipping destination (e.g., the retail store 108) to mention a few examples.

Each of the electronic transaction recording devices 112 comprises a sensor 116, and the sensor 116 is configured to record transactional information associated with the product 110 as the product 110 moves along the supply chain 111 through each of the remote locations 114. Transactional information may include a location of the product 110, the date and time the product 110 is at the location 114, how long the product 110 is at the location 114, what occurs to the product 110 at the location 114, and the nature (or condition) of the location 114 to mention a few examples.

In the example of FIG. 1, a second sensor 118 is associated with the product 110 (e.g., it is disposed in a product shipping container 119 and thus moves with the product 110). The second sensor 118 may report other information about the condition of the product such as the temperature of the product or the weight of the product. Both sensors may also sense a product identifier (e.g., UPC code) or other types of product identification information. In other aspects, the transaction recording device 112 is an internet-of-things (IoT) device. Other examples are possible.

The sensors 116 and 118 may be any type of sensor or combination of sensors. For example, the sensors 116 and 118 may be combinations of cameras, scanners, scales, location determination devices, or thermometers to mention a few examples. The sensors 116 and 118 are configured to obtain any of the transactional information described herein.

Each of the plurality of electronic transaction recording devices 112 causes the transactional information (including product identification information) to be stored on the blockchain ledger 106. The information may be stored in any type of format or organizational structure. Although shown as being stored in the database 104, the blockchain ledger 106 may be a stored at various locations including at the database 104.

The retail store 108 receives the product 110 and sells the product to a customer in a sales transaction. The retail store 108 may be any type of store that sells any variety of products to the public. Alternatively, a product storage facility (e.g., a warehouse or other shipping facility) may be substituted for the retail store 108 to account for on-line, web-based sales. When the product 110 is sold at the retail store 108, the sale transaction is recorded on the blockchain ledger 106, and the sales transaction includes customer identification information and customer contact information. A point-of-sales device 117 (e.g., a scanner or cash register) records the sales transaction. Additionally, customer contact information may be entered automatically or manually using the point-of-sales device.

The control circuit 102 may be disposed at a central location 103 (e.g., a headquarters or home office), but alternatively may be disposed at any of the remote locations 114 or at the retail store 108. In addition, the functions of the control circuit 102 may be split across these locations.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 102 may be configured (for example, by using corresponding programming stored in a memory as will be well understood by those skilled in the art) to carry out one or more of the steps, actions, and/or functions described herein. Although a single control circuit 102 is shown in the example of FIG. 1, it will be appreciated that addition control circuits can be included in or incorporated with, for instance, the transaction recording devices 112.

The control circuit 102 is configured to receive a recall report or notice 123 concerning the product 110. The recall report 123 may be received from a manufacturer, a distributor, a government agency or some other suitable entity. The recall report 123 may be in an electronic form such as an email message.

The control circuit 102 is further configured to access the blockchain ledger 106 and identify customers that purchased the recalled product using the customer identification information.

The control circuit 102 is still further configured to determine an action to take, the action utilizing the contact information of the identified customers that purchased the recalled product. The contact information may include, in aspects, the first name of the customer, last name of the customer, e-mail address of the customer, contact phone number of the customer, and customer address to mention a few examples.

Various locations in the system of FIG. 1 may be considered a node such as the central location 103 (control circuit 102/database), remote locations 114, or the retail store 108. In the system of FIG. 1, copies of the blockchain ledger 106 can be stored at all nodes (or at a sub-set of all nodes). When transactions are added to the ledger 106, a consensus is developed among nodes as to whether to add the transactions that occur along the supply chain 111 or the sales transaction at the store 108. For simplicity, only one control circuit 102 and database 104 are shown and it is located at the central location 103. However, it will be appreciated that others of these devices may be disposed at the various points in the supply chain 111 or other nodes (e.g., at IoT devices or transaction recording devices) or at still other locations and hold copies of the ledger 106.

In aspects, the transactional information is evaluated before the product is received at the retail store 108. In other aspects, after the transactional information is evaluated, the shipment of the product 110 to the store 108 is halted. For instance, the recall report or notice 123 may be received before the product reaches the store 108. In this case, the transactional information on the ledger 106 is evaluated before the product arrives at the store 108. The current location of the product 110 may be determined (e.g., using the last known location of the product 110 as recorded on the ledger 106). A message can be sent to the current location of the product 110 to halt movement of the product 110 and return the product 110 to the supplier, manufacturer, or producer. In this way, the product 110 never reaches the store 108 or the product distribution center. In so doing, valuable resources are saved and cost are reduced since the product 110 does not travel completely through the supply chain 111 only to be returned once it arrives at the store 108.

In other examples, product traceability information of the product is obtained and added to the blockchain ledger 106. The traceability information relates to past or current locations of the product 110. Product traceability information can include locations and dates and times when the product arrived at, stayed at, or left a particular location. The next and/or other future locations where the product 110 is moving may also be included in or derived from the traceability information. In these regards, the traceability information is sufficient to determine past, current, and future locations of the product 110. Traceability information can be used to find the current remote location of the product 110 (e.g., at a particular point in the supply chain 111 or between points in the supply chain 111). For instance, knowing when the product 110 left a point on the supply chain and the next location, the product 110 may be located, for instance, by messaging a delivery truck delivering the product 110.

Each of the remote locations 114 may be a location of the producer of the product 110, a location of a supplier of the product 110, or a location of a shipper of the product 110. Other examples of remote locations are possible.

In examples, the action comprises sending an electronic message to customers who purchased the recalled product or receiving a returned product at an automated vehicle 121. The automated vehicle 121 may be an aerial drone of automated ground vehicle. In examples, the automated vehicle may travel to a customer location (e.g., customer home) to retrieve the product or may receive the product at the store 108. In other examples, the automated vehicle may move the product within the store 108 to a suitable location, e.g., to ship/return the product to a manufacturer or to repair the product. Other examples of actions are possible.

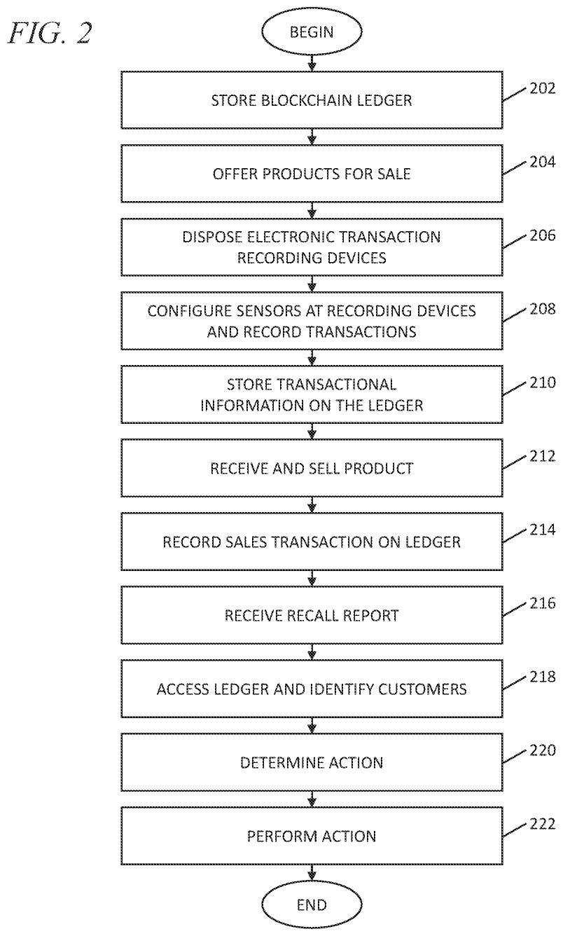

Referring now to FIG. 2, one example of an approach for taking action upon a recall utilizing a blockchain ledger is described.

At step 202, a blockchain ledger is stored, for example, in a database. The blockchain ledger includes a verified list of transactions of a product as the product moves through a supply chain (e.g., from manufacturer to distributor, to shipper, to retail store). The ledger (or copies of the ledger) may be stored at various nodes in a blockchain system.

At step 204, products are offered for sale at a retail store. The retail store may be any type of store that presents or offers products for sale to the public. The products may be any type of product sold to customers. Alternatively, the retail store may be a storage facility (such as a warehouse) and products are sold and shipped from this facility, for example, from sales over the internet (web-based or online sales).

At step 206, a plurality of electronic transaction recording devices are disposed at separate remote locations. In some examples, the transaction recording devices may be IoT devices (or may be associated with IoT devices). The remote locations are transaction points in a supply chain. The product moves through each of the remote locations and to the retail store where the product is to be eventually sold.

Each of the electronic transaction recording devices comprises a sensor, and, at step 208, the sensor is configured to record transactional information associated with a product moving along the supply chain through each of the remote locations. Transactions are recorded.

At step 210, the plurality of transaction recording devices cause the transactional information to be stored on the blockchain ledger. For example, the transaction recording devices may obtain information concerning the product (e.g., location, temperature, condition, identification number) and send this information to be recorded on the ledger using a publishing request. After the information is verified (according to known blockchain procedures), the information is stored at the ledger. The ledger may be stored at a database and copies stored at various locations.

At the retail store and at step 212, the product is received and (later) sold to a customer in a sales transaction. For example, the customer may visit the retail store and purchase the product. In other examples, the product may be shipped at warehouse and the sales transaction may occur on-line where the customer orders the product over a web page.

At step 214, the sale transaction is recorded on the blockchain ledger, and the sales transaction includes customer identification information. The customer identification information may include the name of the customer, one or more email addresses of the customer, the address of the customer, and/or the phone number of the customer to mention a few examples. The customer information may be entered in a variety of different ways. In one example, the customer may enter the information themselves at a point-of-sales device. In another example, the customer may enter (or swipe) a credit card or store card (e.g., a credit card type card that, for instance, offers savings or other “perks” to customers if the customers scan or swipe the card at the checkout or at some other location), information for the credit or store card may be automatically retrieved (e.g., by using a computer network to access address information associated with the credit or store card). In still other examples, a store employee may enter the contact information of the customer via a point-of-sale device. When the sales transaction is on-line, shipping information may be obtained from the customer and this may be the customer identification information.

At step 216, a recall report or notice is received concerning the product. For example, the recall notice may be received at a retail store, a distribution center, or a central processing center. The recall notice may be an electronic message that identifies the product being recalled. Other information may be included in the recall notice.

At step 218, the blockchain ledger is accessed and customers that purchased the recalled product are identified using the customer identification information. The ledger may be accessed from the database, or a local copy may be accessed.

At step 220, an action to take is determined. The action utilizes the contact information of customers that purchased the recalled product.

At step 222, the action is performed. In examples, the action comprises sending an electronic message to customers who purchased the recalled product or receiving a returned product at an automated vehicle. Other examples of actions are possible.

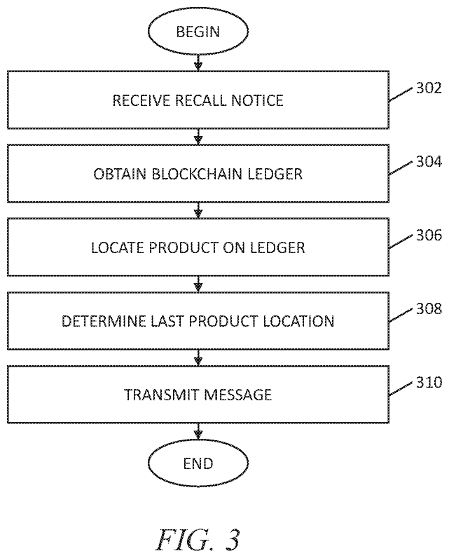

Referring now to FIG. 3, one example of an approach to tracking down a product that has been recalled is described.

At step 302, a recall notice is received. For example, the recall notice may be received at a retail store, a distribution center, or a central processing center. The recall notice may be an electronic message that identifies the product being recalled. Other information may be included in the recall notice.

At step 304, a block chain ledger is obtained. The block chain ledger may be a distributed ledger having copy at all nodes and include a list of all transactions that have occurred with the product. For example, the ledger may associate a product identification number (identifying the product) with events. For example, the product moves through a supply chain and the location of the product, the time the product is at the location, and potentially other information concerning the product may be stored at the ledger. The product may be an individual product (e.g., of a certain brand) or a group of products (e.g., a box of produce).

At step 306, information concerning the product is located on the ledger. For example, a search is made of the ledger until all instances of the product is located.

At step 308, the last product location is determined from the contents of the ledger. For instance, if the date/times of the product's path through a supply chain are listed, then the latest time can be determined. This can be used to determine if the product is still at this location. Alternatively, the product may have left the last location listed on the ledger.

In any case, at step 310, an electronic message may be transmitted to the last known location of the product or the next expected location of the product. The electronic message may specify that the product is to be returned to the manufacturer (or some other location such as a warehouse). In this way, the product is intercepted before it reaches the final retail store (or other final location such as a distribution center or warehouse). Consequently, transportation and other costs may be saved since the product does not reach its final destination.

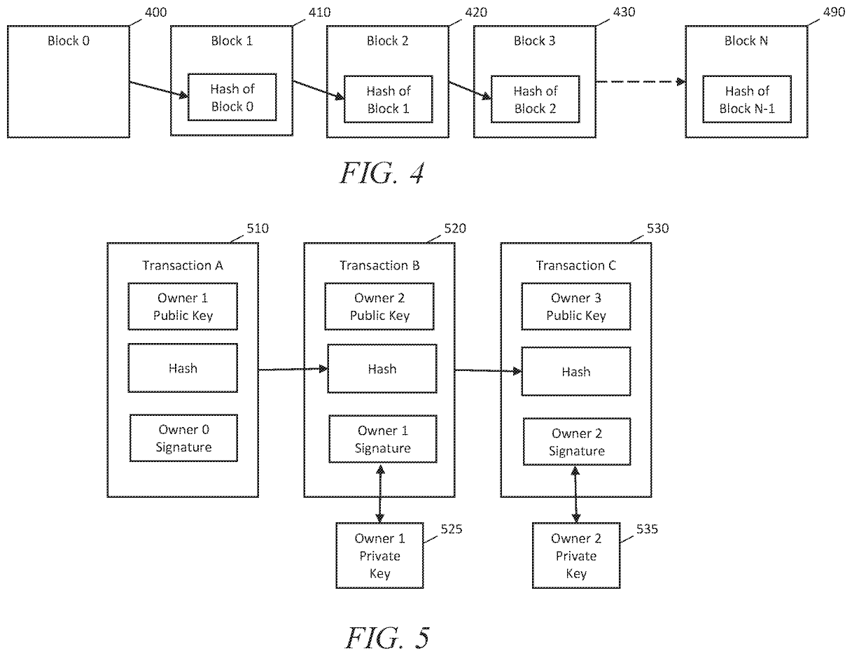

Descriptions of some embodiments of blockchain technology are provided with reference to FIG. 4-9 herein. In some embodiments of the invention described above, blockchain technology may be utilized to record sales transactions, and other information about a product or group of products as the product moves through various locations in a supply chain. One or more of the locations may have devices (e.g., control circuits, electronic transaction recording devices, user devices, computers, processing devices, or IoT devices to mention a few examples) described herein may comprise a node in a distributed blockchain system storing a copy of the blockchain record. Updates to the blockchain may comprise new sales transaction data or new data as the product moves through the supply chain and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N-1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

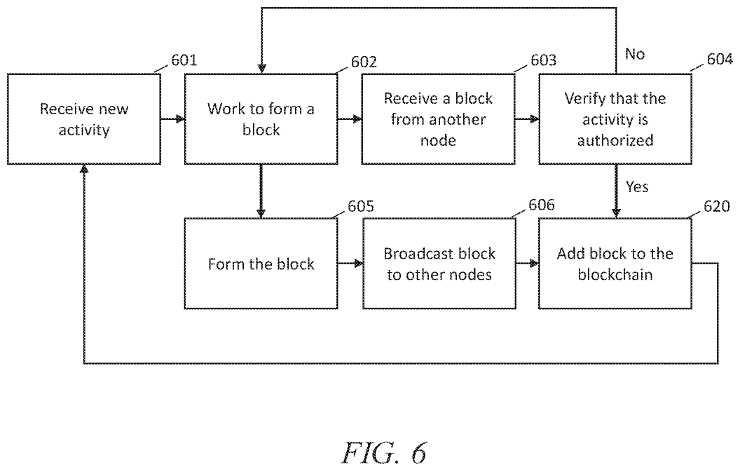

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise a asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

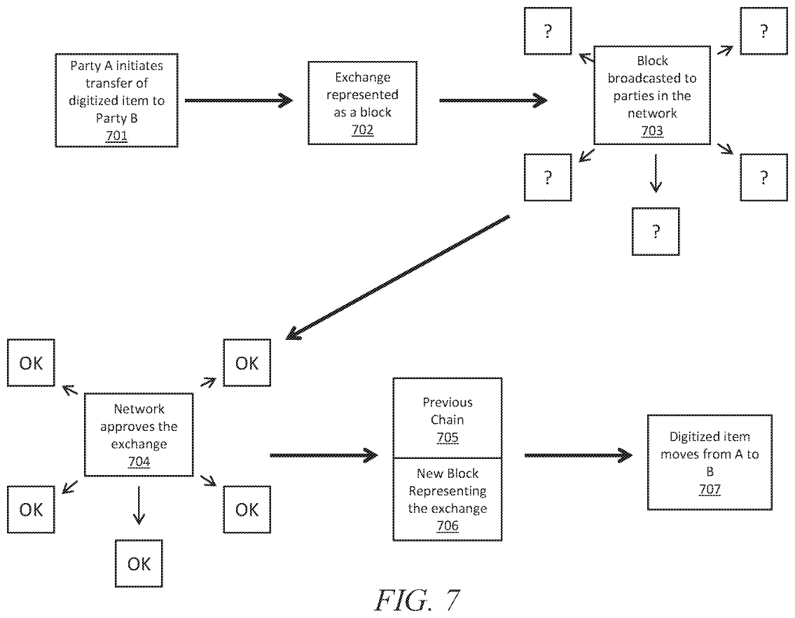

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

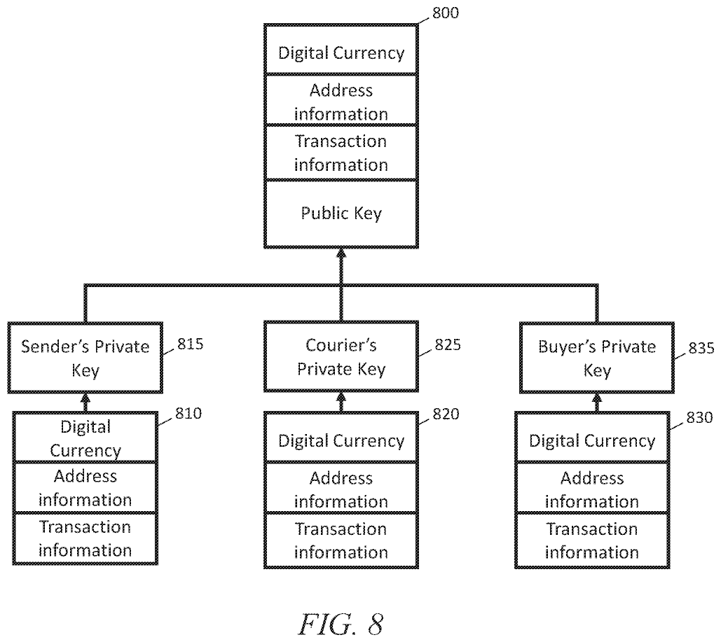

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

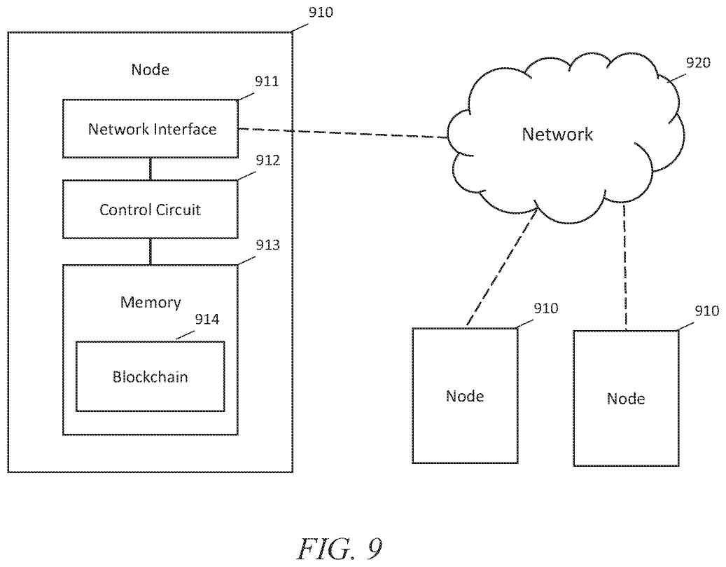

Now referring to FIG. 9, a system according to some embodiments is shown. A distributed blockchain system comprises a plurality of nodes 910 communicating over a network 920. In some embodiments, the nodes 910 may be comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, one or more of the exemplary embodiments include one or more localized IoT devices and controllers (e.g., at the remote locations or with the product as the product moves through the supply chain). As a result, in an exemplary embodiment, the localized IoT devices and controllers can perform most, if not all, of the computational load and associated monitoring and then later asynchronous uploading of data can be performed by a designated one of the IoT devices to a remote server. In this manner, the computational effort of the overall system may be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernals of data in order to filter out data that may reflect generic background data. In an exemplary embodiment, KRG incrementally sequences all future undefined cached kernals having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data. In an exemplary embodiment, KRN and KRI, also incrementally sequences all future undefined cached kernels having encoded asynchronous data in order to filter out data that may reflect generic background data.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to perform remedial actions upon the occurrence of a product recall, the system comprising:
a control circuit and a database;
a blockchain ledger stored at the database;
a retail store or product storage location that offers a product for sale;
a plurality of electronic transaction recording devices disposed at separate remote locations, the remote locations being transaction points in a supply chain, such that the product moves through each of the remote locations and to the retail store or product storage location, wherein each of the electronic transaction recording devices comprises a sensor, the sensor being configured to record transactional information associated with the product as the product moves along the supply chain through each of the remote locations, each of the plurality of electronic transaction recording devices causing the transactional information to be stored on the blockchain ledger;
wherein the retail store or product storage location receives the product and sells the product to a customer in a sales transaction, and wherein the sale transaction is recorded on the blockchain ledger, the sales transaction including customer identification information and customer contact information;
wherein the control circuit is configured to:
receive a recall report concerning the product;
access the blockchain ledger and identify customers that purchased the recalled product using the customer identification information;
determine an action to take, the action utilizing the contact information of the identified customers that purchased the recalled product.

2. The system of claim 1, wherein the transactional information is evaluated before the product is received at the retail store or product storage location.

3. The system of claim 2, wherein after the transactional information is evaluated, the shipment of the product to the store is halted.

4. The system of claim 1, wherein product traceability information of the product is obtained and added to the blockchain ledger, the traceability information relating to past or current locations of the product.

5. The system of claim 1, wherein each of the remote locations is selected from the group consisting of a location of the producer of the product, a location of a supplier of the product, or a location of a shipper of the product.

6. The system of claim 1, wherein the transaction recording device is an internet-of-things (IoT) device.

7. The system of claim 1, wherein the action comprises sending an electronic message to customers who purchased the recalled product or receiving a returned product at an automated vehicle.

8. The system of claim 1, further comprising a second sensor disposed with the product, the second sensor transmitting information associated with a condition of the product, the sensed information being stored on the blockchain ledger.

9. The system of claim 1, wherein the sales transaction is an on-line sales transaction.

10. A method for determining remedial actions upon the occurrence of a product recall, the method comprising:
storing a blockchain ledger;
offering products for sale at a retail store or product storage location;
disposing a plurality of electronic transaction recording devices at separate remote locations, the remote locations being transaction points in a supply chain, such that the product moves through each of the remote locations and to the retail store or product storage location, wherein each of the electronic transaction recording devices comprises a sensor, the sensor configured to record transactional information associated with a product moving along the supply chain through each of the remote locations, the plurality of transaction recording devices causing the transactional information to be stored on the blockchain ledger;
at the retail store or product storage location, receiving the product and selling the product to a customer in a sales transaction;
recording the sale transaction on the blockchain ledger, the sales transaction including customer identification information;
receiving a recall report concerning the product;
accessing the blockchain ledger and identifying customers that purchased the recalled product using the customer identification information;
determining an action to take, the action utilizing the contact information of customers that purchased the recalled product.

11. The method of claim 10, wherein the transactional information is evaluated before the product is received at the retail store or product storage location.

12. The method of claim 11, wherein after the transactional information is evaluated, the shipment of the product to the store is halted.

13. The method of claim 10, wherein product traceability information of the product is obtained and added to the blockchain ledger, the traceability information relating to past or current locations of the product.

14. The method of claim 10, wherein each of the remote locations is selected from the group consisting of a location of the producer of the product, a location of a supplier of the product, or a location of a shipper of the product.

15. The method of claim 10, wherein the transaction recording device is an internet-of-things (IoT) device.

16. The method of claim 10, wherein the action comprises sending an electronic message to customers who purchased the recalled product or receiving a returned product at an automated vehicle.

17. The method of claim 10, further comprising disposing a second sensor with the product, the second sensor transmitting information associated with a condition of the product, the sensed information being stored on the blockchain ledger.

18. The method of claim 10, wherein the sales transaction is an on-line sales transaction.
